(19) United States
(12) Patent Application Publication
(10) Pub. No.: US 2006/0089147 A1
(43) Pub. Date: Apr. 27, 2006

(54) Mobile network infrastructure for applications, personalized user interfaces, and services

(76) Inventor: Robert M. Beaty, Plano, TX (US)

Correspondence Address: AKIN GUMP STRAUSS HAUER & FELD, LLP, P O BOX 688, DALLAS, TX, 75313-0688, US

(21) Appl. No.: 11/253,780

(22) Filed: Oct. 19, 2005

Related U.S. Application Data
(60) Provisional application No. 60/621,020, filed on Oct. 21, 2004.

(51) Int. Cl. H04Q 7/20

(52) U.S. Cl. 455/445

(57) ABSTRACT

A mobile network infrastructure or platform for applications, personalized user interfaces and services is disclosed. The mobile platform provides a plurality of applications and services to subscribers or end-users of mobile or wireless devices. The platform allows the subscribers or end-users to personalize the look-and-feel of the mobile desktop and user interfaces. The mobile platform includes a server infrastructure linked to a plurality of client infrastructures via a communication link. The server infrastructure includes a database server configured to store data, a file storage configured to store the mobile platform's operating system, a Web server configured to execute and process incoming client requests, and a communications application configured to transmit and receive communications. The client infrastructure includes a runtime engine that acts as an operating system for the client infrastructure and is configured to manage communications with the server infrastructure, a plurality of applications that provide functionalities to the client infrastructure, and a shell configured to control the runtime engine and to manage the user interface of the client infrastructure.

### CROSS-REFERENCE TO RELATED APPLICATIONS

This application claims the benefit under 35 U.S.C. § 119(e) of U.S. Provisional Patent Application No. 60/621,020, filed Oct. 21, 2004, which is incorporated herein in its entirety for all purposes.

### BACKGROUND OF THE INVENTION

The invention relates generally to a mobile network infrastructure. More specifically, the invention relates to a mobile network infrastructure for applications, personalized user interfaces and services.

Although recent advances in technology has created the possibility of applications, personalized user interfaces and services being available to mobile or wireless devices, attempts to develop a mobile network infrastructure or platform that provides applications, personalized user interfaces and services to mobile devices have not been commercially successful. Existing mobile infrastructures or platforms are primarily single-purpose mobile platforms such as, for example, e-mail pagers. These single-purpose mobile platforms do not offer a single wireless environment in which subscribers, or end-users, can download and run a wide range of mobile applications that work together seamlessly. Also, existing mobile platforms do not allow end-users to configure their mobile desktop with desktop components, but only offer static menus with predetermined and provider-controlled icons and applications.

Furthermore, existing mobile platforms offer only text based instant messaging with limited support for static icons. Also, existing platforms do not provide cross-application communications and interoperability. Also, existing mobile platforms do not support private labeling by partner companies. Private labeling allows one or more partner companies to easily re-brand a service including the user interface with the partner companies' own look and feel. A few existing platforms require a high degree of custom development to support private labeling by a company and most platforms lack the ability to support the private labeling of a single service simultaneously by multiple partner companies.

Accordingly, there is a need for a mobile infrastructure or platform that allows subscribers or end-users to download and run a wide range of mobile applications that work together seamlessly. There is also a need for a mobile platform that allows subscribers or end-users to configure their wireless desktop with desktop components. There is also a need for a mobile platform, which supports private labeling by partner companies.

### BRIEF SUMMARY OF THE INVENTION

The invention is generally directed to a mobile network infrastructure or platform for applications, personalized user interfaces and services. The mobile platform provides a plurality of applications and services to subscribers or end-users of mobile or wireless devices. The platform allows the subscribers or end-users to personalize the look-and-feel of the mobile desktop and user interfaces.

The mobile platform includes a server infrastructure linked to a plurality of client infrastructures via a communication link. The server infrastructure includes a database server configured to store data, a file storage configured to store the mobile platform's operating system, a Web server configured to execute and process incoming client requests, and a communications application configured to transmit and receive communications. The client infrastructure includes a runtime engine that acts as an operating system for the client infrastructure and is configured to manage communications with the server infrastructure, a plurality of applications that provide functionalities to the client infrastructure, and a shell configured to control the runtime engine and to manage the user interface of the client infrastructure.

The mobile platform allows the subscribers or end-users to move applications including desktop components around on their mobile desktop. Once placed, the desktop components remember their position and provide the end-users with various information such as, for example, weather forecasts, stock prices, unread e-mails, appointments, sports highlights and breaking news at a glance.

The mobile platform allows applications to work together seamlessly. For example, a weather desktop component application on the mobile desktop, when clicked, causes the platform to locate and launch another application that provides detailed weather forecast information. A stock-ticker component application on the mobile desktop, when clicked, causes the platform to locate and launch another application that provides detailed financial information and news related to the stock-ticker symbol. The platform provides applications containing contact functionality that provide other applications on the mobile infrastructure with an integrated means to browse a contact list and return a list of selected contacts' e-mail address.

The mobile platform allows an application to provide reusable services to register its capability, allowing other applications on the platform to search and reuse the capability as needed. The platform allows broadcasting of messages from the server infrastructure to the client infrastructure. The broadcasts may appear as a message balloon on the subscriber's or end-user's mobile device. The message balloons may offer the subscriber or end-user the option to view the information in more detail or take some action regarding the broadcast. When the end-user presses a view button on the message balloon, the platform locates and launches an appropriate program such as a message application and may send an included start-up command to the program which displays a specific piece of information or takes a specific action such as open a specific literature document related to the broadcast.

Furthermore, the mobile platform allows subscribers or end-users to send instant messages to other users in the form of an animated character. When an end-user's friend signs in, an animated character representing the friend can appear in real-time on the end-user's mobile desktop, indicating that the friend is online. These animated characters can be placed by the end-user anywhere on the desktop by using drag and drop and the animated characters remember their location from session to session. The end-users can send an instant message to friends represented by these animated characters by tapping on the character, causing a menu to appear which allows the end-user to type and send a message. The animated characters can also respond to “emoticons”, which are character symbols that commonly represent expressions in instant messaging systems. The infrastructure supports a wide range of possible “emoticons” that can be “acted-out” by the animated characters. For example, a smile [symbol] emoticon can be acted out by an animated character visually and can be accompanied with audio. Multiple emoticons in a single message are interpreted as a timed-sequence of animations that are acted out by the animated characters.

Furthermore, the mobile platform provides themes. The themes change the visual appearance of the desktop and may also incorporate logic which can perform actions such as allowing the end-users to rent a movie, or buy a concert ticket. Additionally, the themes may opt-in end-users to receive real-time broadcast updates related to the themes.

### BRIEF DESCRIPTION OF THE SEVERAL VIEWS OF THE DRAWINGS

A better understanding of the present invention can be obtained when the following detailed descriptions of various disclosed embodiments are considered in conjunction with the following drawings, in which:

FIG. 1 is a simplified block diagram of a mobile network platform in accordance with one embodiment of the invention.

FIG. 2 illustrates a Server Infrastructure in accordance with one embodiment of the invention.

FIG. 3 illustrates a Client Infrastructure in accordance with one embodiment of the invention.

FIGS. 4A and 4B show a flow diagram of the steps executed during end-user logon as it related to the Instant Messaging Character Application or IM Avatar Application in accordance with one embodiment of the invention.

FIG. 5 is a flow diagram of the steps required to send an instant message using the IM Avatar Application in accordance with one embodiment of the invention.

FIG. 6 is a flow diagram of the steps required for receiving an instant message in accordance with one embodiment of the invention.

FIG. 7 shows the steps required for saving the X and Y coordinates of an Instant Messaging Character or IM Avatar.

FIG. 8 is a flow diagram of the steps executed during the end-user logon as it relates to Desktop Component Applications in accordance with one embodiment of the invention.

FIG. 9 shows the steps for launching an Application related to the Desktop Component Applications.

FIG. 10 shows a screenshot of the user interface of a Mobile Device in accordance with one embodiment of the invention.

FIGS. 11A, 11B and 11C show screenshots of the user interface for managing Instant Messaging Characters or IM Avatars in accordance with one embodiment of the invention.

FIG. 12 shows a screenshot of a user interface for enabling and disabling Desktop Component Applications.

FIGS. 13A and 13B show the invention's broadcast features in accordance with one embodiment of the invention.

### DETAILED DESCRIPTION OF THE INVENTION

This application claims the benefit under 35 U.S.C. § 119(e) of U.S. Provisional Patent Application No. 60/621,020, filed Oct. 21, 2004. The Provisional Application No. 60/621,020 includes program code related to the invention, which was submitted in a compact disk. The Provisional Application including the program code is incorporated herein in its entirety for all purposes.

The invention will now be described in detail by referring to diagrams. In the description that follows, the terms “mobile” and “wireless” are used interchangeably, and the terms “infrastructure” and “platform” are used interchangeably. The terms “end-user” or “subscriber” generally refer to the user of a mobile or wireless device and these terms are used interchangeably. The terms “client”, and “remote client” generally refer to a software running on a mobile or wireless device.

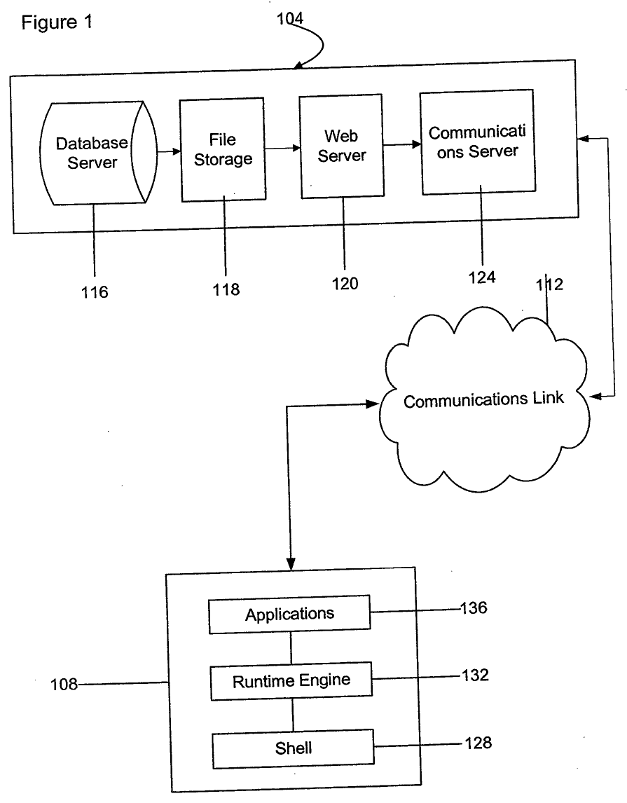

FIG. 1 is a simplified block diagram of a mobile network platform 100 in accordance with one embodiment of the invention. The mobile platform 100 includes a Server Infrastructure 104 linked to a Client Infrastructures 108 via a Communication Link 112. While FIG. 1 shows only one Client Infrastructure 108, in reality a plurality of Client Infrastructures will be linked to the Server Infrastructure 104. The Communication Link may be a wired, a wireless link, a fiber optic link, the Internet or any other type of communication link or network. The Client Infrastructure 108 may be a remote client device such as, for example, a mobile device, a personal digital assistant (PDA), a pocket PC, a mobile phone, or any other computing device operating remotely.

The Server Infrastructure 104 includes one or more Database Servers 116, which store data such as, for example, application configuration data, list of end-users, end-user account data, lists of end-users' provisioned applications, and lists of end-user's friends. The Server Infrastructure 104 also includes a File Storage 118, which stores the mobile platform's operating systems, including one or more runtime operating systems. The File Storage 118 also stores applications, such as, for example, instant messaging applications, desktop component applications, common dialogs application, icon applications or modules, themes applications, private label applications and private label configuration files.

The Server Infrastructure 104 also includes one or more servers such as, for example, Web Servers 120, which execute and process incoming requests from the Client Infrastructure 108. In one embodiment, the Web Servers 120 are implemented using Microsoft ASP.NET server modules. The Web Servers 120 forward client requests to the Database Servers 116. The Web Servers 120 manage interactions between the Client Infrastructure 108 and the Database Servers 116 and the File Storage 118. The Web Servers 120 retrieve applications or files from the File Storage 118 and send the applications or files to the Client Infrastructure 108 over the communications link 112.

The Web Servers 120 also manage interactions between the Client Infrastructure 108 and Communications Applications 124 by forwarding messages through a queue such as, for example, a Microsoft Message Queue. The Web Servers 120 compress data in order to decrease bandwidth requirements and transmission time over the communication link. The compressed data is then transmitted to the Client Infrastructure 108.

The Communications Applications 124 transmit and route communications originating at the Server Infrastructure 104 to the Client Infrastructures 108. The Communications Applications 124 also receive and route communications originating at the Client Infrastructures intended for the Server Infrastructure 104 or other Client Infrastructure 108. In one embodiment, the outbound communications are transmitted via, for example, a TCP/IP link as an e-mail or as a SMS text message.

The Communications Applications 124 detect emoticons in messages. The emoticons are a sequence of ordinary characters that represent, for example, an expression, an object, or actions. When emoticons are detected, the Communications Applications 124 convert the emoticons into a timed sequence of animations and then transmit the message to the Client Infrastructures. For example, the message “8-) hello ;-)” may be converted into a string which encodes a timed interval and animation action pair, which may result in the following sequence being sent to the end-user recipient: “0,1,2,2”, where the first and third numbers represent a number of seconds and the second and fourth numbers are IDs representing a specific animation such as “show sun glasses” and “wink.”

The Client Infrastructure 108 includes a Shell 128 coupled to an Operating System (OS). The Operating System is generally known as a Runtime Engine 132 in the mobile platform. The Runtime Engine 132 supports one or more Applications 136. The Runtime Engine 132 loads the Applications 136 and executes the Applications 136. The Applications 136 may reside in the Client Infrastructure 108 or may be retrieved from the Server Infrastructure 104 by the Runtime Engine 132. For example, upon demand by the Server Infrastructure 104 or the end-users (i.e., the Client Infrastructure 108), the Runtime Engine 104 retrieves Applications from the Server Infrastructure 104.

The Shell 128 loads the Runtime Engine 132. The Shell 128 manages non-visual logic (i.e., logic that does not include visual assets) pertaining to the management of the user interface of a mobile device, such as executing logic for scrolling desktop icons from left to right or minimizing applications. The Shell 128 provides an abstraction layer for user interface layout for the Runtime Engine 132. The abstraction layer allows a single shell to incorporate logic to manage themes, which are graphical “skins” or styles. In one embodiment of the invention, the functionality of the Shell 128 may be incorporated into the Runtime Engine 132.

The Runtime Engine 132 manages communications with the Web Servers 120 in the Server Infrastructure 104. The Runtime Engine 132 also performs typical tasks associated with operating systems such as process management, publish and subscribe event management and file management. Additionally, built in functions or callable application programming interfaces (APIs) are included in the Runtime Engine 132 for developers' use, thus eliminating the need for re-coding tasks that are already built into the Runtime Engine 132. Examples of these APIs include functions that minimize applications, send data across the network to the Web Servers 120, send an instant message, close an application, and retrieve a list of the end-user's friends.

In one embodiment, the Runtime Engine 132 allows the Applications 136 to register as a provider of various reusable functionalities. Based on the available applications for a specific end-user, the Rutime Engine determines if any applications provide re-usable functionality. The Runtime Engine reads a field in the application data sent from the Web Servers 120 to determine if the applications provide any reusable functionality. If the Runtime Engine 132 detects applications that provide a re-usable functionality, the Runtime Engine stores a name describing the functionality and the corresponding application's ID that are accessible to other applications via the Runtime Engine's API. Other applications seeking to re-use the functionality, use the API to locate the functionality and interact seamlessly across application barriers. For example, an application containing contact information can display to an end-user other capabilities such as determining near-by stores, getting driving directions, calculating shipping rates, or accessing weather forecasts. Thus, the application containing contact information does not need to include any weather, shipping, driving directions, etc., within its code base. Instead, the application can access the additional capabilities, which are provided by other existing applications by using the Runtime Engine's API.

The Applications 136 are loaded by the Runtime Engine 132. The Applications 136 may be, for example, a balloon message application, an instant messaging character application, a theme application, a desktop component application or other application modules. Themes are applications that change the “skin” or appearance of the Client Infrastructure's user interface. The themes may include executable logic, which allows the end-user to perform actions such as, for example, rent a movie or buy movie tickets which the theme graphically depicts.

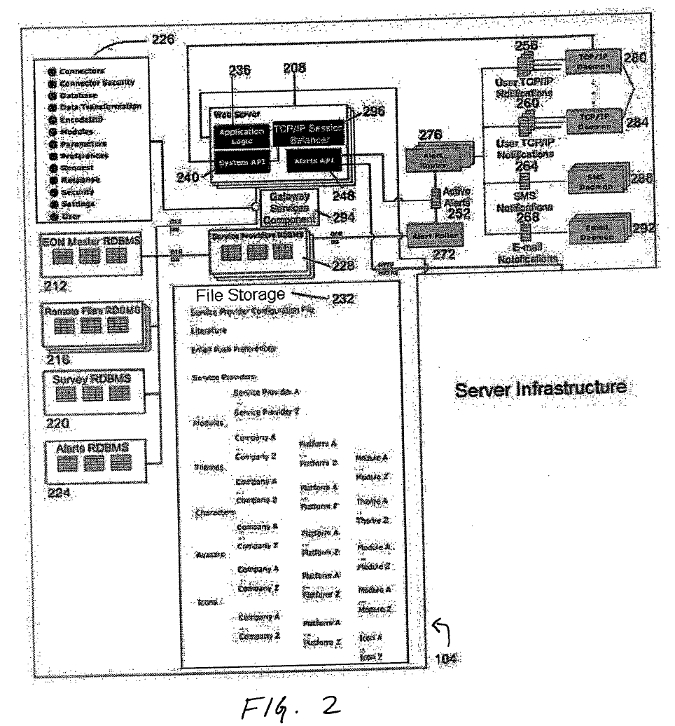

FIG. 2 illustrates the Server Infrastructure 104 in further detail in accordance with one embodiment of the invention. In one embodiment, the Server Infrastructure 104 is connected, through the Internet, to a plurality of Client Infrastructures (not shown in FIG. 2). The Server Infrastructure 104 may be connected to the Client Infrastructures through other types of connection.

The Server Infrastructure 104 includes one or more networked Web Servers 208 configured to run common Web server software. In one embodiment, the Web Servers 208 are Microsoft Windows-based servers configured to run common Web server software such as, for example, Microsoft Internet Information Services and Microsoft Active Server Pages.NET. The Web Servers 208 manage and interact with one or more remote databases that are linked to the Web Servers 208. In one embodiment, the remote databases may be relational database management systems (RDBMS) and may be implemented by, for example, Microsoft SQL Servers. In one embodiment, the Web Servers 208 manage and interact with a Master RDBMS 212, a Remote files RDBMS 216, a Survey RDBMS 220, an Alert RDBMS 224, and a Service Providers RDBMS 228.

The Server Infrastructure 104 includes a File Storage System 232. In one embodiment, the Web Servers 208 manage and access the File Storage System 232. The Web Servers 208 retrieve data from the File Storage System 232 and store data into the File Storage System 208.

The File Storage System 232 stores the mobile platform's operating systems, including one or more runtime operating systems. The File Storage System 232 also stores applications, such as, for example, instant messaging applications, desktop component applications, common dialogs application, icon applications or modules, themes applications, private label applications and private label configuration files. As will be understood by those skilled in the art, the application modules in the File Storage System 232 may be accessed by the Web Servers 208 executing Middleware Application Logic 236 housed in the Web Servers 208. The middleware logic is an application logic written in a Web server compatible language such as, for example, VB.Net, C#, or Microsoft Active Server Pages. The middleware logic handles incoming request from the end-users, and returns information that may be the result of a calculation, data from the databases, or perform other common operations typical of Web server programs.

In one embodiment of the invention, the Server Infrastructure 104 includes an Object Model 226, which includes a plurality of system application programming interfaces (APIs) 240. As will be apparent to those skilled in the art, the APIs 240 provide access to commonly needed re-usable logic routines often used by the Application Logic 236. Examples of the common logic routines include functions for saving or retrieving settings and authenticating incoming client requests by validating against end-users' credentials, which may be stored in the database. The APIs 240 may also perform standard string encoding and decoding for special characters to avoid conflicts with XML, HTML or other markup language.

In another embodiment, the APIs 240 may reside in a Gateway Services Component 294 accessible by the Web Servers 208. As will be apparent to those skilled in the art, the Gateway Services Component 294 can be stored in an operating system's Global Assembly Cache, which allows any application on the Server Infrastructure to access and reuse the APIs in the Gateway Services Component 294.

In yet another embodiment, the Server Infrastructure 104 includes an Alerts API 248 that may reside in the Web Server 208, and which executes within the Web Server 208. As will be apparent to those skilled in the art, the Alerts API 248 provides XML interfaces callable by any computer that supports Microsoft Web Services and also has access to the Web Servers 208 via an Internet or local network connection. The Alerts API 248 places alert messages into one or more message queues. In one embodiment of the invention, the message queues are implemented as Microsoft Message Queue services 252,256,260,264,268 accessible by the Web Servers 208.

The Server Infrastructure 104 includes one or more Alert Pollers 272. In one embodiment, the Alert Pollers 272 poll, or query, the Service Provider RDBMs 228 for alert messages that are scheduled for release and places the alert messages in an Active Alerts Queue 252 linked to the Alert Pollers 272. The Alert Pollers 272 may be used to poll other databases or File Storage Systems.

The Server Infrastructure 104 includes one or more Alert Routers 276. The Alert Routers 276 access the Active Alerts Queue 252. The Alert Routers 276 listen for incoming messages on the Active Alerts Queue 252 and retrieve the incoming messages. The Alert Routers 276 place the incoming messages in one or more Message Queues 256, 260, 264 and 268.

In one embodiment, the Server Infrastructure 104 includes one or more TCP/IP Daemons 280, 284 that may access the Web Servers 208. The TCP/IP Daemons 280, 284 listen for new messages in the Message Queues 256, 260 which are dedicated to the end-users and send the messages to the corresponding end-user's mobile device using TCP/IP connection. In one embodiment, the TCP/IP Daemons 280, 284 are implemented by Microsoft Windows Services.

The Server Infrastructure 104 includes one or more Short Messaging Service (SMS) Daemons 288 (e.g., implemented by Microsoft Windows Services), which listen for new messages in the SMS Notifications Queue 264 and send the messages to the end-user's SMS e-mail address via SMTP protocol. The Server Infrastructure 104 includes one or more E-mail Daemons 292, which listen for new messages in the E-mail Notifications Queue 268 and send the messages to the end-user's e-mail address via SMTP protocol. SMTP is a standard protocol that supports the transmission of e-mail messages from a server such as a Microsoft Windows Server.

The Server Infrastructure 104 includes a TCP/IP Session Balancer 296, which may execute within the Web Servers 208. The TCP/IP Session Balancer 296 manages the TCP/IP Daemons 280 or 284 that an end-user connects to based on factors such as current load on each of the TCP/IP Daemons 280. The TCP/IP Session Balancer 296 updates the databases as end-users connect and disconnect in real-time and helps track the utilization of the TCP/IP Daemon 280 or 284 via querying, for example, a database.

In one embodiment of the invention, various modules, applications and components of the Server Infrastructure 104 are written using Microsoft Visual Basic .Net for Microsoft Active Server pages .NET and Microsoft SQL Server. Also, HTML and JavaScript are incorporated into the modules, applications and components of the Server Infrastructure 104.

In another embodiment of the invention, various modules, applications and components of the Client Infrastructure 108 are written using Microsoft Visual Basic .Net, Macromedia Flash and ActionScript. Also, HTML and JavaScript are incorporated into the modules, applications and components of the Client Infrastructure 108.

As will be understood by those skilled in the art, the modules, components, applications and other elements of the present invention can be implemented using other programming languages.

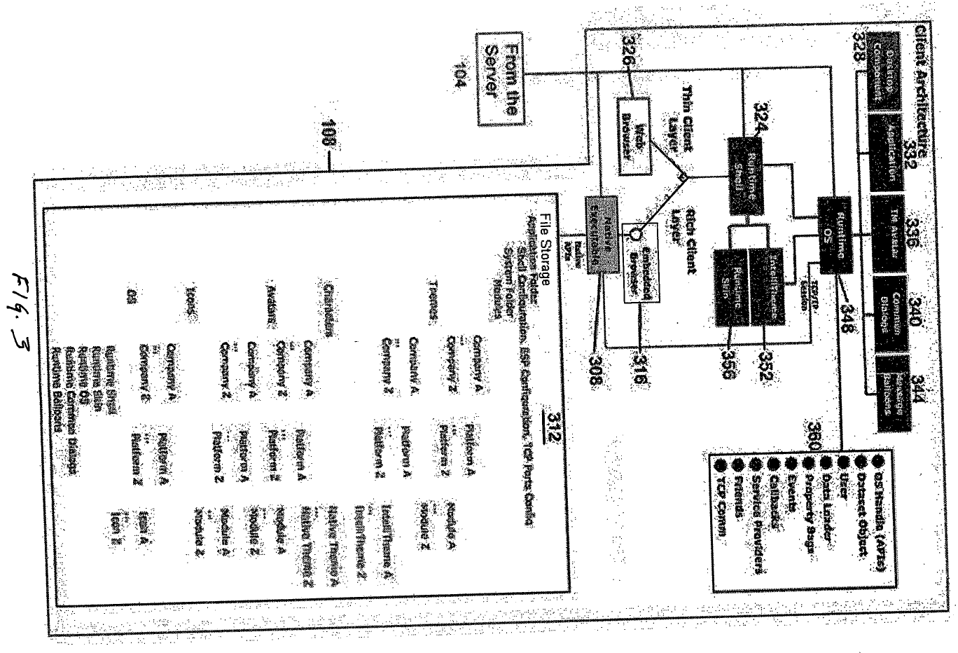

FIG. 3 illustrates the Client Infrastructure 108 in further detail in accordance with one embodiment of the invention. As will be understood by those skilled in the art, the Client Infrastructure 108 may be a mobile or wireless device; a hand-held computer; a personal digital assistant; a mobile phone; or any other computing device. The Client Infrastructure 108 is linked by a communication link 112 to the Server Infrastructure 104 shown in FIGS. 1 and 2.

The Client Infrastructure 108 includes a Native Executable 308. As will be understood by those skilled in the art, the Native Executable 308 is a program that runs on the Client Infrastructure's native operating system. The Client Infrastructure 108 also includes a storage mechanism such as, for example, a non-volatile RAM or a hard drive which may include a File Storage 312. The storage mechanism is accessible by the Native Executable 308, and it may be used for caching data and files and for storing system settings. In one embodiment, the Native Executable 308 is a program written in Visual Basic .Net and is compatible with Microsoft's device operating systems. In another embodiment, the Native Executable 308 includes an Embedded Browser 316 such as, for example, Microsoft Internet Explorer, which provides standard Web-browsing functionality.

The Client Infrastructure 108 also includes a Runtime operating system (OS) 348. As will be understood by those skilled in the art, the Runtime OS 348 utilizes the Native Executable 308 to save and retrieve information from a storage mechanism such as, for example, the File Storage 312. Alternately, in another embodiment of the invention there is no Native Executable, but a Web Browser 326 acts as a host for a Runtime Shell that will be described later.

In one embodiment, the Runtime Shell 324 may reside in the Web Browser 320 or the Embedded Browser 316. The Runtime Shell 324 loads the Runtime OS 348 and a Runtime Skin 356 upon start-up.

The Runtime OS 348 loads other applications such as, for example, a Desktop Component Application 328, Instant Messaging Application or (IM) Avatar 336, Common Dialogs Application 340, Message Balloons Application 344, Themes Application 352, and other Applications 332. In one embodiment, the Runtime Shell 324 and the Applications are implemented in Macromedia Flash open standard. The Runtime Shell 324 manages non-visual logic (i.e., logic that does not include visual assets) pertaining to the management of the user interface of a mobile device, such as executing logic for scrolling desktop icons from left to right or minimizing applications. The Runtime Shell 324 also maintains a TCP/IP connection to the Server Infrastructure 104.

Also, the Runtime Shell 324 is responsible for non-visual logic pertaining to the management of the user interface, including dynamic branding or private labeling through the use of the Runtime Skins 356. The Runtime Skins 356 provide an abstraction layer of user interface layout and control for the Runtime OS 348. End-users can request the Runtime Skins 356 from the Web Servers 208 by sending an ID which identifies a specific Runtime Skin file located on the Web Servers. The Web Servers 208 respond with a Runtime Skin 356 file containing visual user interface elements and color scheme for the branding. Acting as an abstraction layer, the Runtime Shell performs typical logic required by the Runtime Skins 356. This allows the Runtime OS 348 to perform its functions independent of the current Runtime Skin 356.

In one embodiment, the Runtime OS 348 includes an Object Model 360 with typical operating system logic for reading and writing data over the Internet connection by communicating with the Server Infrastructure 104, launching applications, event subscriptions using a publish and subscriber methodology, providing callbacks to applications. As will be understood by those skilled in the art, callbacks provide a mechanism for applications to request the Runtime OS 348 to execute a specific function within the original calling application.

The Object Model 360 allows applications to perform common tasks such as authentication as well as providing a high level object model view allowing the applications to access user information and table, row and column information using a pre-built set of functions.

The Runtime OS 348 provides re-usable logic that allows applications to load data into the Client Infrastructure 108. The Runtime Shell 324 and Runtime OS 348 cooperatively provide the capability to “skin” or change the theme of the Client Infrastructure 108. The theme controls the visual appearance of the end-user's desktop as well as the color scheme for system objects such as default font colors, and application header colors.

In one embodiment, the Client Infrastructure 108 includes Themes Application 352, which provide visual customization capability to the Client Infrastructure 108. The Themes Application 352 may change the appearance of the Client Infrastructure 108. Also, the Themes Application 352 selected by the end-users may include application logic capable of supporting mobile commerce such as one-tap rental of a movie, subscriptions to real-time notifications which are initiated from the Server Infrastructure 104, and other operations such as embedding a real-time email ticker on the desktop background, which are supported by the Runtime OS 348 and the Runtime Shell 324.

In another embodiment, the Runtime Skin 356 is controlled by the Server Infrastructure 104 and is based on the end-users' private label brand that will be described later.

The Desktop Component Applications 328 (also referred to as Widgets) are used by the end-user to customize the appearance of a mobile device's (i.e., Client Infrastructure) desktop. The Desktop Component Applications 328 provide information at a glance to the end-user and may perform operations supported by the Runtime OS 348 and the Runtime Shell 324. Other Applications 332 are applications that may be loaded by the Runtime OS 348 and may execute logic and perform operations supported by the Runtime OS 348 and the Runtime Shell 324. The Desktop Component Applications 328 will be described in detail later.

The IM Avatars 336 are animated instant messaging character applications. The IM Avatars 336 are also referred to as instant messaging characters. The IM Avatars 336 may be loaded by the Runtime OS 235. In one embodiment, the IM Avatars 336 are animated interactive graphical representations of the end-user's online friends. The IM Avatars 336 appear on the end-user's desktop indicating the presence of a friend on the network. The IM Avatars 336 provide instant messaging functionality. Also, the IM Avatars 336 can act out, through animation and sound, various emoticon symbols in a timed sequence. The IM Avatars 336 will be described in detail later.

The Common Dialogs Application 340 provides reusable dialog boxes for applications loaded by the Runtime OS 348. These dialog boxes may be used to display common system dialogs such as a Yes/No dialog or a Time or Date input dialog.

The Message Balloons Application 344 provide balloon-shaped dialog boxes usable by applications loaded by the Runtime OS 348. The balloon-shaped dialog box displays a message and provides one or more buttons which the end-user may select.

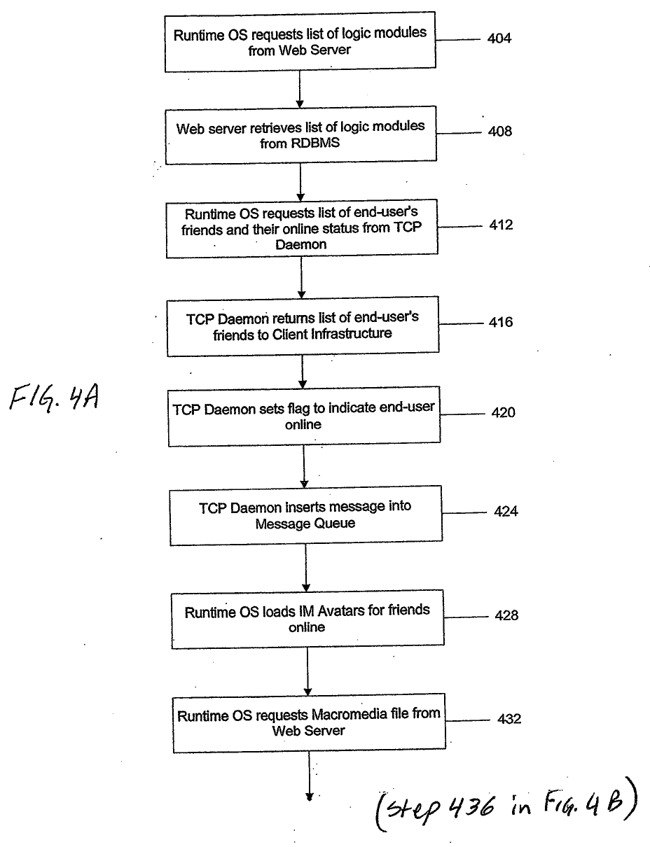

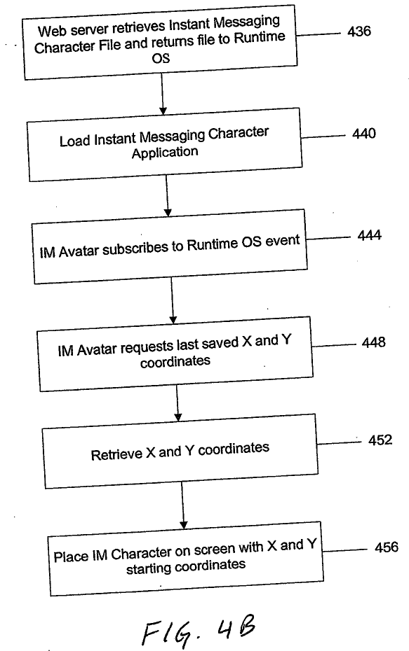

FIGS. 4A and 4B are a flow diagram of the steps executed during the end-user logon as it relates to the IM Avatars 336 (of FIG. 3) in accordance with one embodiment of the invention. Note, the items listed in the flow charts of FIGS. 4 through 9 may refer to items in FIGS. 2 and 3. The Runtime OS 348 requests the Web Server 208 a list of applications for which the end-user or subscriber has access to (step 404). The Web Server 208 then retrieves the list of applications from the Service Provider RDMBS 228 or other storage mechanism. In one embodiment, the retrieved list of applications is returned to the end-user over HTTP or HTTPS protocol for further processing (step 408).

Next, the Runtime OS 348 requests a list of the end-users' friends and the friends' current online status from the TCP/IP Daemon 280 or 284 (step 412). The TCP/IP Daemon 280 or 284 retrieves the list of friends from the RDBMS 228 or other storage and returns the list to the Client Infrastructure 108 (e.g., a mobile device) via, for example, a TCP/IP connection (step 416)

The TCP/IP Daemon 280 or 284 sets a flag on the end-users' record in the Service Provider RDBMS 228 to indicate the end-user is currently online (step 420). The TCP/IP Daemon 280 or 284 inserts a message into the end-user's friends' dedicated Message Queues 256 or 260 indicating the end-user is now online (step 424).

After the Client Infrastructure 108 receives the list of friends, the Runtime OS 348 loads the IM Avatars 336 for the friends that are online (step 428). In order to load the IM Avatar Application 336, the Runtime OS 348 requests an animated instant messaging character application from the Web Server 208. In one embodiment, the animated instant messaging character application is a Macromedia Flash (.swf) file (step 432). The Web Server 208 retrieves the animated instant messaging character application, which is identified by a unique file name from the File Storage 232 (step 436). The Runtime OS loads the animated instant messaging character application (step 440). The IM Avatar Application 336 subscribes to a predetermined Runtime OS event (e.g., IM_Arrival), which allows the IM Avatar Application 336 to respond to incoming instant messages (step 444). As will be understood by those skilled in the art, subscribing to a Runtime OS event instructs the Runtime OS to call a specific function within the animated instant messaging character application upon occurrence of a predetermined event such as the arrival of an instant message.

The IM Avatar Application 336 requests the last saved X and Y on-screen coordinates from the Web Server 208 to determine its start-up position (step 448). The Web Server retrieves the X and Y on-screen coordinates from a storage mechanism such as, for example, the Service Provider RDBMS 228 where the coordinates were last stored as a result of a change in position of the IM Avatar Application (step 452). The loading sequence is completed by the animated instant messaging character application executing which causes the graphical instant messaging character to be placed on the screen with X and Y as starting coordinates (step 456).

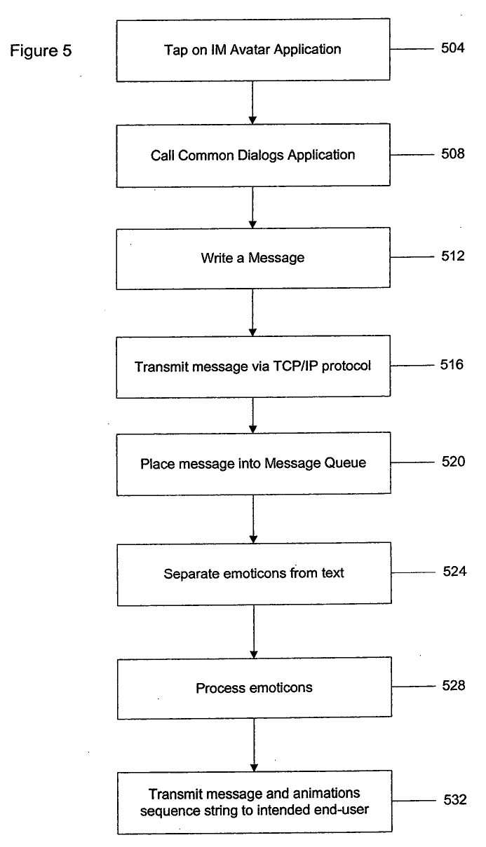

FIG. 5 is a flow diagram of the steps required to send an Instant Message using the IM Avatar Application 336 (i.e., Instant Messaging Characters) in accordance with one embodiment of the invention. When an end-user, or subscriber, wants to send an instant message, the end-user taps on (or otherwise executes) the IM Avatar Application 336 (step 504). In response, the IM Avatar Application 336 calls the Common Dialogs Application 340 to display a text input dialog (step 508). The end-user then writes a message that may include emoticon symbols intermixed with the message text (step 512).

Next, the Runtime OS 348 calls the Runtime Shell 324 to transmit the message via TCP/IP protocol to the Server Infrastructure 104 (step 516). In response, the TCP/IP Daemon places the message into a Message Queue for subsequent processing (step 520). Next, the TCP/IP Daemon parses the message to separate the emoticons from the text portion of the message (step 524). The emoticons are processed based on their character location within the message string and a new string containing an animation sequence based on the emoticons and the character location is created (step 528). The new string contains an ID representing the emoticon animation within the message and a number representing an amount of time for the IM Avatar Application 336 to pause between playing out emoticon animations based on the emoticons' character position within the message. Next, the TCP/IP Daemon transmits the message and the animation sequence string to the intended end-user over a TCP/IP connection (step 532).

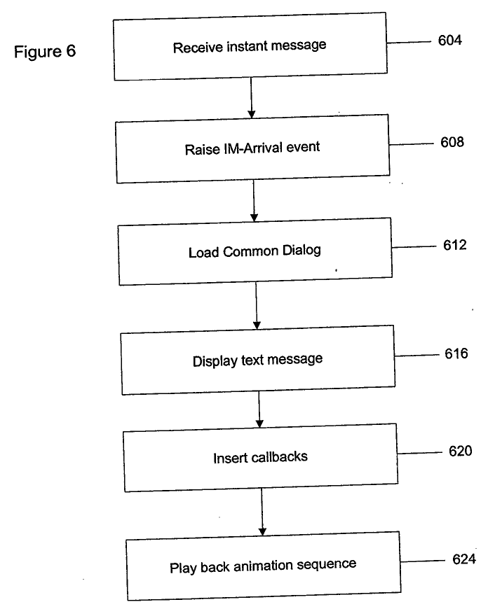

FIG. 6 is a flow diagram of the steps required for receiving an instant message in accordance with one embodiment of the invention. The Client Infrastructure 108 receives the instant message via the TCP/IP connection (step 604). The Runtime Shell 324 forwards the instant message to the Runtime OS 348, which causes the Runtime OS to raise an IM_Arrival event (step 608). The event may have been subscribed earlier by applications such as the IM Avatar Application 336 (i.e., Instant Messaging Characters), as part of the initial login sequence.

Next, the Common Dialog Application is loaded (step 612) and the text message is displayed as it was typed by the sender (step 616). The IM Avatar Application 336 inserts Callbacks into the Runtime OS as dictated by the timed animation sequence (step 620). The Runtime OS 348 waits a predetermined interval as indicated by the Callbacks and the IM Avatar 336 plays back an animation sequence representing the emoticon indicated by the Callbacks as each Callback occurs (step 624).

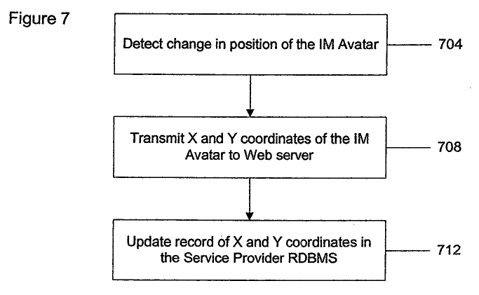

FIG. 7 shows the steps required for saving the X and Y coordinates of an Instant Messaging Character or IM Avatar Application 336 as a result of the IM Avatar Application 336 being moved on a end-user's desktop. The Client Infrastructure 108 detects a change in position of the IM Avatar Application 336 as a result of the end-user dragging the IM Avatar character (step 704). The Runtime OS 348 in the Client Infrastructure transmits the X, Y coordinates of the IM Avatar character via HTTP or HTTPS protocol to the Web Server 208 (e.g., ASP.Net Web Server) in the Server Infrastructure 104 (step 708). The Web Server 208 then updates a record containing the X,Y position of the IM Avatar character in a storage such as, for example, the Service Provider RDBMS 228 (step 712).

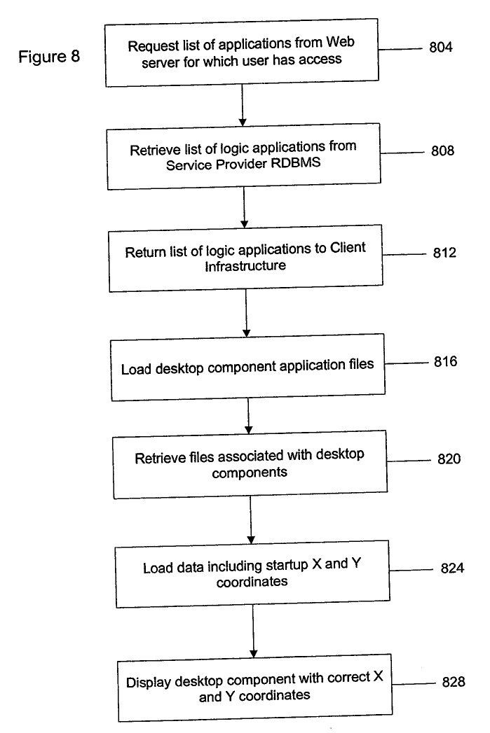

FIG. 8 is a flow diagram of the steps executed during the end-user logon as it relates to the Desktop Component Applications 328 in accordance with one embodiment of the invention. The Runtime OS 348 requests a list of applications from the Web Server 208 for which the logged in end-user has access (step 804). The Web Server 208 retrieves the list applications from a storage mechanism (e.g., the Service Provider RDBMS 228) (step 808). The list of applications is returned to the Client Infrastructure 108 over HTTP or HTTPS protocol (step 812).

After the list of applications is returned to the Client Infrastructure 108, the Runtime OS 348 loads the end-user's Desktop Component Applications 328 (step 816). In one embodiment, the Desktop Component Applications 328 may be implemented as Macromedia Flash (.swf) files. The Web Server 208 retrieves the Desktop Component Application files from a storage mechanism such as, for example, the Hierarchical File System 232 (step 820).

The Desktop Component Applications uses the Runtime OS 348 to load required data from the Web Server 208 including starting X,Y coordinates as last saved in the Service Provider RDBMS 228 or other storage mechanism (step 824). The data retrieved from the Web Server 208 may vary. For example, the types of data which can be retrieved include, but are not limited to, weather forecasts, stock prices, and Unread E-mail messages. Depending on the source and nature of the requested data, the Web Server 208 may retrieve the data from a storage mechanism such as, for example, the Service Provider RDBMS 228 or from an external data source accessible through the Internet such as weather or stock data available in common commercial XML data feeds. A Desktop Component Application interface (i.e., the visual element of the application) is then displayed on the desktop in its correct position with its data as retrieved from the Web Server 208 (step 828).

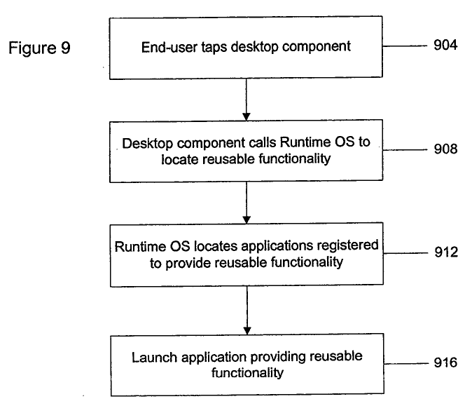

FIG. 9 shows the steps for launching an Application 332 related to the Desktop Component Application 328. The launch is initiated when the end-user clicks or taps on (or otherwise executes) to a visual element in the Desktop Component Application 328 (step 904). The Desktop Component Application 328 calls the Runtime OS 348 to locate an application which has registered to provide the required re-usable functionality (step 908).

The Runtime OS 348 checks against an available application list to locate the Applications 332 that have registered to provide the requested re-usable functionality (step 912). In one embodiment, the re-usable functionalities are identified as a string of characters. For example, the Applications 332 may register to provide re-usable functionalities such as “sendmail” or “getforecast.” The Runtime OS 348 then launches the Application 332 providing the re-usable functionalities (step 916). Optionally, the Desktop Component Applications 328 may pass startup parameters to the Application 332 that is to be launched so that the startup parameters may trigger the Application 332 to execute specific commands or display certain data.

FIG. 10 shows a screenshot of the user interface of a Mobile Device 1000 in accordance with one embodiment of the invention. The Mobile Device 1000 is also referred to as the Client Infrastructure 108 shown in FIG. 3.

As discussed before, the wireless platform of the invention supports a limitless number of user configurable desktop components. In FIG. 10, a Messaging Desktop Component Application 1004, a Weather Desktop Component Application 1008, and a Stock Ticker Desktop Component Application 1012 are shown as examples. The Desktop Component Applications support a wide range of real-time information, which is delivered at-a-glance and available on the end-user's desktop. For example, in FIG. 10, the Messaging Desktop Component Application 1004 can alternate between displaying a list of unread e-mail messages and the end-user's appointments for the day.

A Weather Desktop Component Application 1008 provides the local weather at a glance. A Stock Ticker Desktop Component Application 1012 displays the stock symbols of interest to the user. Additional Desktop Components may be designed using the same architecture to deliver a variety of information at a glance based on user preferences. The invention allows the end-user to place the Desktop Component Applications anywhere on the screen (i.e., the desktop).

Also shown in FIG. 10 is an Animated Instant Messaging Character Application (i.e., IM Avatar) 1016 placed on the desktop. This Animated Instant Messaging Character Application 1016 represents a end-user's friend that is currently signed on to the system. The end-user can tap on the Animated Instant Messaging Character 1016 to open a menu which provides the option to send an instant message to the friend represented by the Animated Instant Messaging Character 1016.

An icon 1020 shown at the lower left of the desktop allows the end-user, with a single tap, to launch an Email Application to compose an e-mail. In one embodiment, the icon 1020 appears only if the user has an application that supports e-mail. Similarly, a friends application icon 1024 appears if the user has a Friends Application. The end-user may launch the Friends Application by tapping on the friends application icon.

The invention generally allows end-users to browse their available applications and folders using the File Navigation System 1028 shown in FIG. 10. The File Navigation System 1028 is designed to occupy only a portion of the screen, leaving the remainder of the screen available for end-user customizable Desktop Component Applications, IM Avatars and other informative visual elements. As with typical file navigation systems, the File Navigation System 1028 supports the browsing of files and folders and launching of applications. The invention supports the ability to remotely add or remove applications and folders from an end-user's desktop based on a list of provisioned applications for the end-user.

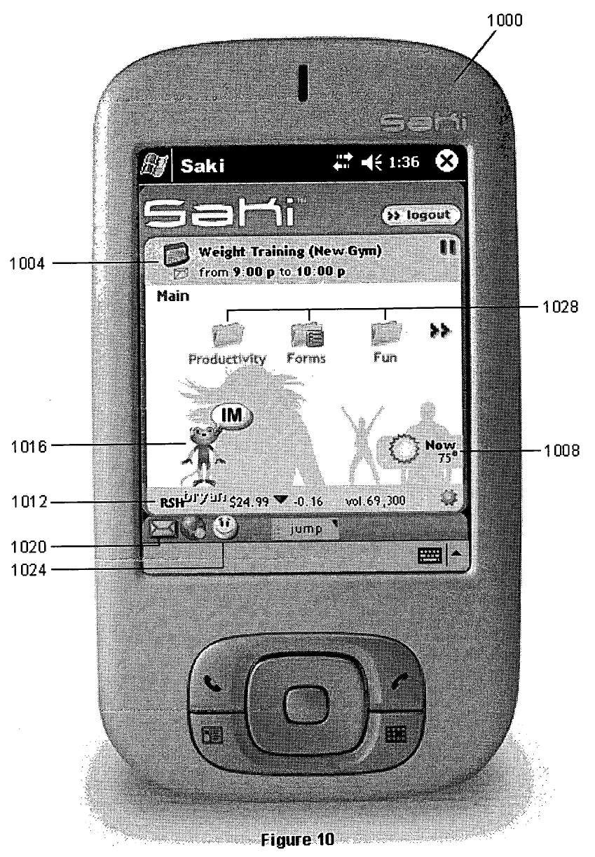

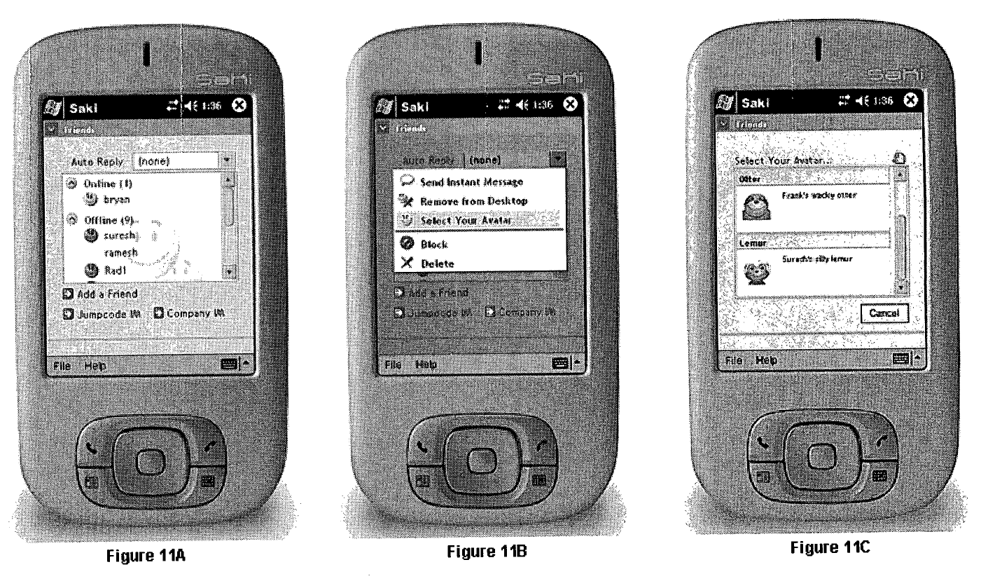

FIGS. 11A, 11B and 11C show screenshots of the user interface for managing Animated Instant Messaging Character Applications or IM Avatars in accordance with one embodiment of the invention. The Friends Application also shown in FIG. 11A visually indicates which of the end-user's friends are currently online and offline. A graphical symbol next to some names indicates that the friends are configured to appear as animated characters on the end-user's desktop when they are online. The end-user can tap on a friend's name in the list shown to open a Menu of available options as shown in FIG. 11B. The Menu shown in FIG. 11B, along with common options found in typical instant messaging systems, allows the end-user to select an Animated Instant Messaging Character Application (i.e., IM Avatars). The Menu leads to a list of Animated Characters shown in FIG. 11C that are available to the end-user. The list of Animated Instant Messaging Character Applications displays the Applications for which the end-user has been given access. By selecting an Application from the list, the end-user configures a desired appearance on his or her friend's wireless desktop. From the Friends Application, the end-user can also select which of their friends will appear on their desktop as Animated Instant Messaging Characters when they are signed on.

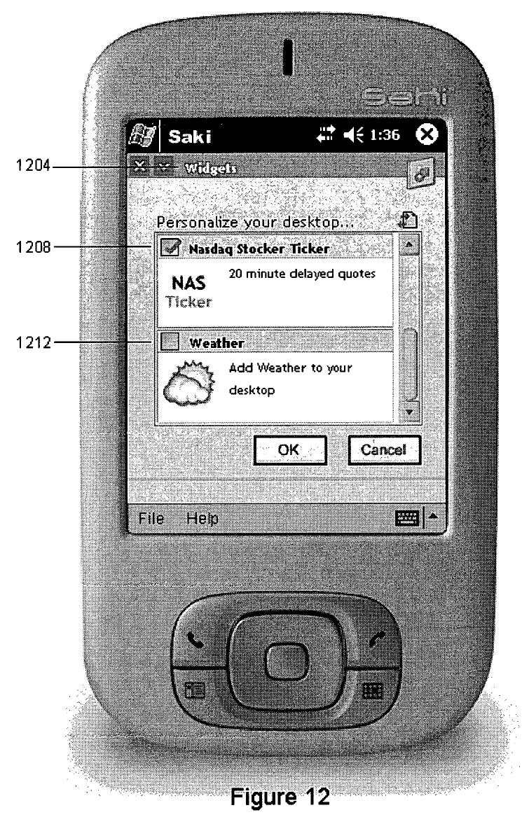

FIG. 12 shows a screenshot of a user interface for enabling and disabling Desktop Component Applications on the end-user's desktop. A Widgets Application 1204 is launched by tapping its application icon in the end-user's system folder. Once launched, the Widgets Application 1204 provides the end-user with a list of available Desktop Component Applications. In FIG. 12, a Stock Ticker Desktop Component Application 1208 has been selected to appear on the desktop.

Also FIG. 12 shows that a Weather Desktop Component Application 1212 is not selected to appear on the end-user's desktop. The Weather Desktop Component Application 1212 provides real-time weather information at a glance. By checking and unchecking the Desktop Component Applications 1208 and 1212 the end-user can turn individual desktop component applications on or off within the Widgets Application 1204.

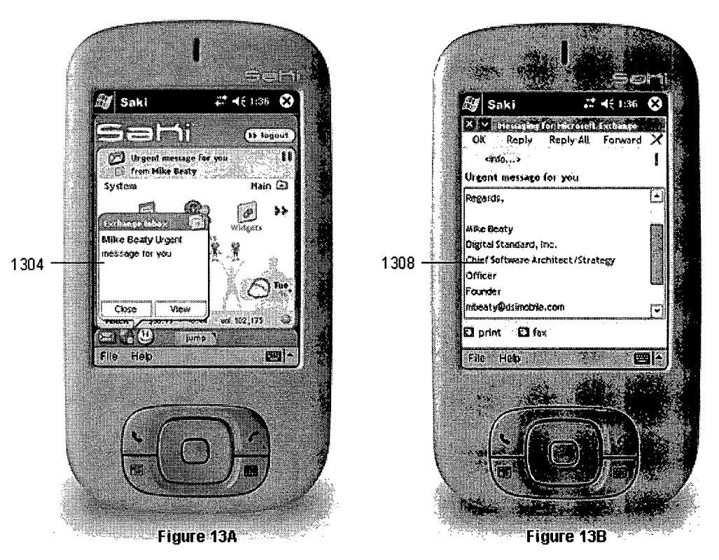

FIGS. 13A and 13B show the invention's broadcast and application interoperability features in accordance with one embodiment of the invention. A Message Balloon Application 1304 shown in FIG. 13A can be broadcast from the Server Infrastructure 104 and delivered to the end-users in real-time. The Message Balloon Application 1304 indicates to the end-user the arrival of a new e-mail. The messaging icon in the Message Balloon Application 1304 indicates that the balloon message is related to the end-user's email application. The Message balloon Application 1304 support a title, a text message, optional startup parameters, and may be associated with an application. This association is based upon a key which is passed to the Message Balloon Application that represents a single application within the system. By clicking the view button on the Message Balloon Application 1304, the application that is specified by the key is located. Additional hidden startup parameters may be passed to the Message Balloon Application, but are not displayed. These startup parameters are passed by the Message Balloon Application to the application launched as a result of the end-user clicking a view button. The launched application, in this example, is the Email Application 1308 shown in FIG. 13B. The launched application uses the startup parameters to take a specific action in response to the view button on the Message Balloon Application 1304. In this case the Email Application 1308 is passed the required identifying information of the e-mail and the command to view it. In response, upon launch, the Email Application reads the startup parameters, which indicate that it should open directly to the requested e-mail message, bypassing screens that would initially appear if no startup parameters were passed, for example, if the Email Application where launched directly from its application icon on the wireless desktop.

The mobile platform supports private labeling. The Web Servers 208 select the end-user's Runtime Skin 356 from the File Storage 232. The Runtime Skin 356 contains the “skin.” The “skin” is a branded graphical user interface for a private label brand. In one embodiment, the Runtime Skin 356 is selected based on a unique identifier such as a 3 character ID passed from the Client Infrastructure 108. The Web Server 208 transmits the Runtime Skin 356 to the Client Infrastructure 108. The Runtime Shell 324 loads the Runtime Skin 356 to implement the private label or branded graphical interface.

Thus, the mobile platform provides the ability to dynamically brand its user interface based on a plurality of Runtime Skins 356. This capability allows the mobile platform to support the private labeling of the service by multiple companies, each with their own brand, while operating on a single implementation of the infrastructure.

While certain exemplary embodiments have been described in detail and shown in the accompanying drawings, it is to be understood that such embodiments are merely preferred and only illustrative of and not restrictive on the broad invention. Other and further embodiments of the invention may be devised without departing from the basic scope thereof, which is determined by the claims that follow. By way of example, and not limitation, the specific components utilized may be replaced by known equivalents or other arrangements of components which function similarly and provide substantially the same result.

I/We claim:

1. A mobile network infrastructure for providing applications, personalized user interfaces and services to a plurality of end-users over a communications network, comprising:
a server infrastructure comprising:
a database server configured to store data;
a file storage configured to store the mobile network infrastructure's operating system;
a web server configured to execute and process incoming client requests; and
a communications application configured to transmit and receive communications; and
a plurality of client infrastructures linked to the server infrastructure via the communications network, each client infrastructure comprising:
a runtime engine operable as an operating system for the client infrastructure and configured to manage communications with the server infrastructure;
a plurality of applications operable to provide functionalities to the client infrastructure; and
a shell configured to control the runtime engine and to manage the user interface of the client infrastructure.

2. The mobile network infrastructure according to claim 1 wherein the web server manages interactions between the client infrastructure and the database server, the file storage and the communications application.

3. The mobile network infrastructure according to claim 1 wherein the web server retrieves applications from the file storage.

4. The mobile network infrastructure according to claim 1 wherein the web server sends applications to the client infrastructure.

5. The mobile network infrastructure according to claim 1 wherein the web server compresses data to reduce the bandwidth prior to transmission of the data to the client infrastructure.

6. The mobile network infrastructure according to claim 1 wherein the database server stores application configuration data.

7. The mobile network infrastructure according to claim 1 wherein the database server stores end-user account data.

8. The mobile network infrastructure according to claim 1 wherein the communications application convert emoticons in a message into a timed sequence of animations.

9. The mobile network infrastructure according to claim 1 wherein the shell provides an abstraction layer for the user interface.

10. The mobile network infrastructure according to claim 1 wherein the runtime engine includes a plurality of application programming interfaces (APIs).

11. The mobile network infrastructure according to claim 1 further comprising an animated instant messaging character application for sending and receiving instant messages.

12. The mobile network infrastructure according to claim 1 further comprising themes application configured to provide the appearance of the user interface.

13. The mobile network infrastructure according to claim 1 wherein the client infrastructure is a mobile device.

14. The mobile network infrastructure according to claim 1 wherein the client infrastructure is a wireless device.

15. The mobile network infrastructure according to claim 1 wherein the communications network is the Internet.

16. The mobile network infrastructure according to claim 1 wherein the communications network is a wireless network.

17. The mobile network infrastructure according to claim 1 wherein the communications network is a wired network.

18. A server infrastructure for a mobile network infrastructure for providing applications, personalized user interfaces and services to a plurality of client infrastructures over a communications network, the server infrastructure comprising:
a web server configured to execute and process requests from the client infrastructures and to manage the server infrastructure;
a file storage configured to store the mobile network infrastructure's operating system and to store a plurality of applications; and
a database configured to store data.

19. The server infrastructure of claim 18 further comprising an object model, wherein the object model includes a plurality of application programming interfaces (APIs) that provide re-usable logic routines.

20. The server infrastructure of claim 18 further comprising one or more alert APIs configured to provide XML interfaces and to place alert messages into message queues

21. The server infrastructure of claim 18 further comprising one or more alert pollers configured to query the database for alert messages.

22. The server infrastructure of claim 18 further comprising one or more alert routers configured to retrieve incoming messages and to place the messages into message queues.

23. The server infrastructure of claim 18 further comprising one or more TCP/IP Daemons configured to send messages to the end-users.

24. The server infrastructure of claim 18 further comprising one or more short messaging service (SMS) Daemons configured to send messages to the end-users.

25. The server infrastructure of claim 18 further comprising one or more e-mail Daemons configured to send e-mail messages to the end-users.

26. The server infrastructure of claim 18 further comprising one or more TCP/IP session balancers configured to balance the load on the TCP/IP Daemons.

27. A client infrastructure for a mobile network infrastructure for providing applications, personalized user interfaces and services to a plurality of end-users over a communications network, the client infrastructure comprising:
a runtime operating system configured to retrieve information from a storage mechanism and to store information in the storage mechanism;
a runtime shell configured to load the runtime operating system upon start-up; and
one or more applications operable to provide functionalities to the client infrastructure.

28. The client infrastructure according to claim 28 further comprising one or more file storages configured to store data and system settings.

29. The client infrastructure according to claim 28 further comprising a native executable configured to retrieve data from the file storage and to save data in the file storages.

30. The client infrastructure according to claim 28 further comprising a runtime skin configured to provide branded graphical user interface for the client infrastructure.

31. The client infrastructure according to claim 30 wherein the runtime skin provides branded graphical user interface and further allows private labeling of a service by multiple companies, each company having its own brand.

32. The client infrastructure according to claim 28 further comprising a browser configured to provide Web browsing capability to the client infrastructure.

33. The client infrastructure according to claim 28 further comprising an instant messaging character application configured to provide communications using instant messaging.

34. The client infrastructure according to claim 28 further comprising a plurality of an animated instant messaging characters configured to a provide graphical representation of the end-users' friends online.

35. The client infrastructure according to claim 28 further comprising a plurality of desktop component applications configured to provide information at-a-glance to the end-users.

36. The client infrastructure according to claim 28 further comprising themes application configured to provide visual customization capability to the client infrastructure.

37. The client infrastructure according to claim 28 further comprising themes application configured to provide mobile commerce capability to the client infrastructure.

38. The client infrastructure according to claim 28 further comprising common dialog application configured to display system dialogs.

39. The client infrastructure according to claim 28 further comprising a message balloon application configured to display messages.

40. A method for sending an instant message using an animated messaging character over a mobile network infrastructure including a server infrastructure linked to a plurality of client infrastructures via a communications network, the method comprising the steps of:
tapping on the animated instant messaging character application in the client infrastructure;
displaying a message input location;
writing a message in the message input location;
transmitting the message to the server infrastructure;
processing the message; and
transmitting the processed message to the intended client infrastructure.

41. The method according to claim 40 wherein the step of writing a message further comprises the step of including emoticons in the message, the emoticons being character symbols representing expressions or objects.

42. The method according to claim 40 wherein the step of processing the message further comprises the steps of:
identifying emoticons in the message;
creating an animation sequence based on the emoticons; and
transmitting the message and the animation sequence to the intended client infrastructure.

43. The method according to claim 42 wherein the animation sequence is created based on the emoticons' location in the message and the amount of time the animated instant messaging character must pause between playing out the emoticons.

44. A method for receiving and displaying an instant message having animated instant messaging characters over a mobile network infrastructure, the infrastructure including a server infrastructure linked to a plurality of client infrastructures via a communications network, the method comprising the steps of:
receiving an instant message at the client infrastructure;
raising a runtime operating system event;
providing emoticon callbacks in accordance with a timed animation sequence of emoticons to an operating system, the emoticon callbacks indicating time intervals during which the instant messaging characters will not act out;
playing animation sequences in accordance with the emoticon callbacks.

45. A method for saving X and Y coordinates of an instant messaging character for sending instant messages over a mobile network infrastructure, the mobile network infrastructure including a server infrastructure linked to a plurality of client infrastructures via a communications network, the method comprising the steps of:
detecting at the client infrastructure, a change in the X and Y coordinates of the instant messaging character as a result of an end-user moving the instant messaging character;
determining the changed X and Y coordinates of the instant messaging character;
transmitting the changed X and Y coordinates of the instant messaging character to the server infrastructure;
updating a record containing the X and Y coordinates in a database in the server infrastructure.

46. A method for loading desktop component applications in a client infrastructure of a mobile network infrastructure having a server infrastructure linked to a plurality of client infrastructure via a communications network, the method comprising the steps of:
requesting desktop component applications for which a logged in end-user has access to from the server infrastructure;
returning the desktop component applications to the client infrastructure;
loading the desktop component applications at the client infrastructure;
loading data associated with the desktop components; and
displaying the desktop component applications with associated data on the client infrastructure.

47. The method according to claim 46 further comprising the steps of:
clicking onto a desktop component application icon;
identifying an application that provides a service associated with the desktop component application; and
launching the application at the client infrastructure.

48. The method according to claim 46 wherein the desktop component application is a messaging desktop application.

49. The method according to claim 46 wherein the desktop component application is a weather desktop component application.

50. The method according to claim 46 wherein the desktop component application is a stock ticker desktop component application.

51. A method for providing branded graphical user interface in a client infrastructure in a mobile network infrastructure, the method comprising the steps of:
retrieving a branded graphical user interface file from a storage in a server infrastructure;
transmitting the branded graphical user interface file to the client infrastructure; and
loading the branded graphical user interface file into the client infrastructure, wherein a private label is provided at the client infrastructure by using the branded graphical user interface.

52. The method according to claim 52 wherein the branded graphical user interface represents a company's label.

53. The method according to claim 52 further comprising the step of providing branded graphical user interface by a plurality of companies having different brands.

54. A method for providing private label of the user interface of a client infrastructure in a mobile network infrastructure by a plurality of companies having different brands, the method comprising the steps of:
retrieving a branded graphical user interface file from storage in a server infrastructure, the branded graphical user interface file representing a company's label;
transmitting the branded graphical user interface file to the client infrastructure;
loading the branded graphical user interface file in the client infrastructure,
wherein private label is provided by the plurality of companies using the mobile network infrastructure.
